(19) United States
(12) Patent Application Publication
(10) Pub. No.: US 2013/0285880 A1
(43) Pub. Date: Oct. 31, 2013

(54) WIDEBAND ELECTROMAGNETIC STACKED REFLECTIVE SURFACES

(71) Applicant: U.S. Army Research Laboratory ATTN:RDRL-LOC-I, Aelphi, MD (US)

(72) Inventors: Amir Ibrahim Zaghloul, Bethesda, MD (US); William O'Keefe Coburn, Dumfries, VA (US)

(21) Appl. No.: 13/848,380

(22) Filed: Mar. 21, 2013

Related U.S. Application Data
(63) Continuation-in-part of application No. 13/713,030, filed on Dec. 13, 2012.
(60) Provisional application No. 61/601,584, filed on Feb. 22, 2012.

(51) Int. Cl. H01Q 15/14

(52) U.S. Cl. CPC H01Q 15/14
USPC 343/912

(57) ABSTRACT

An electromagnetic structure for reflecting electromagnetic waves comprising a first surface having spaced patches of conductive material thereon; a second surface separated from the first surface, having spaced patches of conductive material, the first and second surfaces having high impedance and thrilling substantially optimal magnetic conductors; adapted to be used in conjunction with an associated antenna that radiates electromagnetic radiation originating therefrom, the radiation is reflected by the electromagnetic structure such that the phase of the electromagnetic waves reflected from first and second surfaces results in the constructive addition of the originating and reflected waves. The stacked layers resonate at different frequencies leading to a plurality of resonances at different frequencies resulting in operation of the associated antenna at a broadband of frequencies; the multiple resonances being a function of; inter alia, the spacing between patches of conductive material and the size of the patches.

### CROSS-REFERENCE TO RELATED APPLICATIONS

This application claims benefit of priority to U.S. Nonprovisional Application No. ______, 13/713,030 (ARL 11-19) filed Dec. 13, 2012, entitled “A Broadband Electromagnetic Band-Gap (EBG) Structure,” by Dr. Amir Zaghloul and Dr. Steven Weiss, which in turn claims the benefit of U.S. Provisional Patent Application No. 61/601,584, filed Feb. 22, 2012, both of which are herein incorporated by reference.

### STATEMENT OF GOVERNMENT INTEREST

The invention described herein may be manufactured, used, and licensed by or for the United States Government without the payment of royalties.

### BACKGROUND OF THE INVENTION

A problem encountered with electromagnetic wave propagation from an antenna is that when the antenna is placed near a surface there is a reflection of waves caused by the surface. By putting a perfect metal conductor behind an antenna, a reflection will occur at −180 degrees phase difference which leads to cancellation of the radiating waves. Placement of the sheet at one quarter wavelength alleviates this problem but requires a minimum thickness or spacing of λ/4. However, spacing the antenna at one quarter wavelength of the center frequency so that the reflected wave and the radiated wave constructively combine (along the boresight of the antenna) tends to consume excessive space. Moreover, surface currents or waves may develop in the metal sheet, leading to the propagation of interfering waves of radiation.

In the article entitled “High-Impedance Electromagnetic Surfaces with a Forbidden Frequency Band,” IEE Transactions on Microwave Theory and Techniques,” Vol. 47, No. 11, November 1999, pages 2069-2074, herein incorporated by reference, there is described a type of metallic electromagnetic structure that is characterized by having high surface impedance, and although it is made of continuous metal, and conducts dc currents, it does not conduct ac currents within a forbidden frequency band. Unlike normal conductors, the surface does not support propagating surface waves, and its image currents are not phase reversed. The geometry is analogous to a corrugated metal surface in which the corrugations have been folded up into lumped-circuit elements, and distributed in a two-dimensional lattice. The uses include low profile antennas.

The publication by E. Yablonovitch, entitled “Photonic band-gap structure,” J. Opt. Soc. Amer. B, Opt. Phys., vol.10, pp 283-295, (Feb. 1993) describes how a photonic semiconductor can be doped, producing tiny electromagnetic cavities. The article postulates that structures made of positive dielectric-constant materials, such as glasses and insulators, can be arrayed into a three-dimensionally periodic dielectric structure, making a photonic band gap possible, employing a purely real, reactive, dielectric response. The photonic band gap described in the Yablonovitch reference refers to the band gap or an area where electron-hole recombination into photons is inhibited.

Electromagnetic band gap structures are usually periodic consisting of metal patches that are separated by a small gap and vias or pins that connect the patches to the ground plane. The electrical equivalent circuit consists of a resonant tank circuit, whose capacitance is represented by the gap between the patches and the inductance represented by the via. See in this regard D. Sievenpiper, L. Zhang, R. Broas, N. Alexopolous, and E. Yablonovitch, “High-impedance frequency selective surface with forbidden frequency band,” IEEE Trans. Microwave Theory Tech. ,vol. 47, pp 2059-2074, Nov. 1999, and/or D. Sievenpiper, “High-impedance Electromagnetic Surfaces,” Ph. D. dissertation, Dep. Elect.Eng. Univ. California at Los Angeles, Los Angeles, Calif., (1999) (hereinafter Sievenpiper dissertation), both of which are hereby incorporated by reference.

The Sievenpiper Dissertation states at page 134, Clearly, any radio frequency can be obtained by adjusting the value of the sheet capacitance and sheet inductance. The goal is usually to make the thickness much less than the operating wavelength. Since the thickness is linked to the inductance, low frequencies are usually achieved by loading the structure with large capacitors. However, this reduces the bandwidth. Therefore, the primary trade-off in the design of a high impedance surface is usually the thickness versus the bandwidth.

Sievenpiper's variations are ways to increase the frequency range over which the resonance can be tuned but the result is still a narrow band resonance.

The electronic band gap (EBG) structures are in effect a magnetic surface at the frequency of resonance and thus have very high surface impedance. This makes a tangential current element close to the electronic band gap structure equivalent to two current elements oriented in the same direction without the electronic band gap structure, which helps to enhance the forward radiation instead of completely canceling it, as suggested by the image theory. This makes electronic band gap structures useful when mounting an antenna close to a ground plane, provided the antenna's currents are parallel to the electronic band gap structure. Electronic band gap structures have previously been known to operate over a very narrow band, and thus not useful with a broadband antenna.

As described in U.S. patent application Ser. No. 13/713,030, hereby incorporated by reference, electromagnetic band gap structures are generally passive devices useful in conjunction with antennas that provide a reflective surface “behind” the antenna to allow for phase difference that does not lead to cancellation of the propagating wave. Electromagnetic band gap structures may, for example, be periodic structures that have special properties, such as high surface impedance (which prevent the abovementioned surface currents). Accordingly, a ground plane having electronic band gap structures formed thereon can act as a near-perfect magnetic conducting structure, and therefore suppress the formation of surface waves. Heretofore, the terminology “band gap” referred to the operation of the device between the stop band, where waves are not propagated and the pass band, where waves are propagated leading to the creation of a “band gap” in the frequency region where waves are propagated. However, the structures being described herein is not limited to a band gap structures per se.

It would be desirable to provide an electromagnetic band gap structure having a phase response suitable for use with a broadband antenna, that is, having an ultra-wideband (UWB) operational phase response which is greater than, for example, 500 MHz.

### SUMMARY OF THE INVENTION

An electromagnetic structure for reflecting electromagnetic waves comprising a first surface having spaced patches of conductive material thereon; a second surface separated from the first surface, having spaced patches of conductive material, the first and second surfaces having high impedance and forming substantially optimal magnetic conductors; the electromagnetic structure adapted to be used in conjunction with an associated antenna that radiates electromagnetic radiation originating therefrom, the radiation is reflected by the electromagnetic structure such that the phase of the electromagnetic waves reflected from first and second surfaces results in the constructive addition of the originating and reflected waves, thus enhancing the radiation of electromagnetic waves by the associated antenna. Each of the first and second surfaces comprise stacked layers resonating at a different frequency leading to a plurality of resonances at different frequencies resulting in operation of the associated antenna at a broadband of frequencies. The multiple resonances being a function of the spacing between patches of conductive material and the size of the patches. The conductive material portions are substantially planar and are substantially parallel to one another; the electromagnetic waves being reflected in the forward direction, away from the first surface. The first and second layers may be separated by at least one dielectric material; wherein the spacing between the first and second layers forms a resonant cavity.

An alternate preferred embodiment comprises an electromagnetic structure for reflecting electromagnetic waves comprising a first planar area comprising a first plurality of spaced apart patches of conductive material; the first plurality of spaced apart patches operating to reflect electromagnetic waves in a first frequency range; a second planar area substantially parallel to and separated from the first planar area, the second planar area comprising a second plurality of spaced apart patches of conductive material operating to reflect electromagnetic waves in a second frequency range; a third planar area substantially parallel to and separated from the first and second planar areas, the third planar area comprising a third plurality of spaced apart patches of conductive material operating to reflect electromagnetic waves in a third frequency range; the first, and third frequency ranges being additive such that the electromagnetic structure reflects electromagnetic waves in a ultra wide frequency band; whereby the electromagnetic structure is adapted to be used in conjunction with an associated antenna that radiates electromagnetic radiation originating therefrom, the radiation being reflected by the electromagnetic structure being such that the phase of the electromagnetic waves reflected from first and second layers results in the constructive addition of the originating and reflected waves, thus enhancing the radiation of electromagnetic waves by the associated antenna.

The alternate preferred embodiment electromagnetic structure may further comprising a base layer which conforms in shape to the object upon which the electromagnetic structure is secured, the object being one of a human body, aircraft and motor vehicle and wherein the range of the ultra wide frequency band exceeds 500 MHZ. The first, second and third plurality of patches may have different sizes so as to produce a resonate effect at different ranges of frequency. The structure may optionally comprise a base and, optionally, the first, second and third plurality of patches may extend in two dimensions, and be supported by a first, second and third plurality of supports, the first supports extending between the first plurality of patches and second plurality of patches, the second supports extending between the second plurality of patches and third plurality of patches, the third supports extending between the third plurality of patches and the base.

The alternate preferred embodiment may optionally include a region between the first planar area and second planar area comprising a first resonant cavity and a region between the second planar area and third planar area comprising a second resonant cavity, the first and second resonant cavities each operating to form first and second resonant tank circuits; the capacitance of the first resonant tank circuit being dependent upon the distance between the first and second plurality of patches, and the capacitance of the second resonant tank circuit being dependent upon the distance between the second and third patches, and wherein the inductance of the first and second resonant tank circuits comprises the electrical characteristics of the first and second supports, respectfully.

In accordance with the principles of the present invention, the preferred embodiments may operate to reflect electromagnetic radiation from the antenna such that the phase of the electromagnetic waves reflected from first, second and third planar areas results in the constructive addition of the originating and reflected waves, thus enhancing the radiation of electromagnetic waves by the associated antenna.

Optionally the first, second and third plurality of patches may extend in two dimensions, and be supported by a first, second and third dielectric layers; whereupon the region between the first planar area and second planar area comprises a first resonant cavity and the region between the second planar area and third planar area comprises a second resonant cavity, the first and second resonant cavities each operating to form first and second resonant tank circuits; the capacitance of the first resonant tank circuit being dependent upon the distance between the first and second plurality of patches, and the capacitance of the second resonant tank circuit being dependent upon the distance between the second and third patches, and wherein the inductance of the first and second resonant tank circuits comprises the electrical characteristics of the first, second and third dielectrics, respectively.

### BRIEF DESCRIPTION OF THE DRAWINGS

The foregoing and other objects, features, and advantages of the invention will be apparent from the following more detailed description of the preferred embodiments of the invention, as illustrated in the accompanying drawings, wherein:

FIG. 1 is an overhead view schematic illustration of a preferred embodiment of the present invention.

FIG. 2 is a side view schematic illustration of a preferred embodiment of the present invention.

FIG. 3 is a graphical comparison of the reflection phases a preferred embodiment 3-layer stacked structure and a uniform structure.

FIG. 4 is a schematic illustration of an ultra wideband antenna used with a 3-layer stacked preferred embodiment structure.

FIG. 5 is a graphical comparison of the gain patterns of the ultra wideband antenna in free space.

FIG. 6 is a graphical comparison of the gain patterns of the ultra wideband antenna on a PEC plate.

FIG. 7 is a graphical comparison of the gain patterns of the ultra wideband antenna near a uniform electronic band gap antenna.

FIG. 8 is a graphical comparison of the gain patterns of the ultra wideband antenna near a stacked preferred embodiment structure.

FIG. 9 is a boresight gain comparison of the ultra wideband antenna under different loading conditions.

FIG. 10 is a graphical comparison of the return loss of the antenna under different loading conditions with respect to a 50 ohm input.

FIG. 11A is an isometric view showing different periodicity in the three layer preferred embodiment of the present invention.

FIG. 11B is an overhead view schematic illustration of an alternate preferred embodiment of the present invention.

FIG. 12A is a side view showing a stacked structure of a preferred embodiment of the present invention with vias.

FIG. 12B is a side view showing a stacked structure of a preferred embodiment of the present invention without vias.

FIG. 13 is a schematic illustration of an alternate preferred embodiment of the present invention showing an enlarged view in the upper right corner.

FIG. 14 is a schematic illustration of exemplary antennas with which embodiments of the present invention may be utilized.

FIG. 15 is a schematic illustration of additional exemplary antennas with which embodiments of the present invention may be utilized.

FIG. 16 is a schematic three dimensional configuration of an alternate preferred embodiment wherein the patches 11-56 are support by a dielectric.

A more complete appreciation of the invention will be readily obtained by reference to the following Description of the Preferred Embodiments and the accompanying drawings in which like numerals in different figures represent the same structures or elements. The representations in each of the figures are diagrammatic and no attempt is made to indicate actual scales or precise ratios. Proportional relationships are shown as approximates.

### DESCRIPTION OF THE PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention. Rather, these embodiments are provided so that this disclosure will be thorough and complete, and will fully convey the scope of the invention to those skilled in the art. In the drawings, the dimensions of objects and regions may be exaggerated for clarity. Like numbers refer to like elements throughout. As used herein the term “and/or” includes any and all combinations of one or more of the associated listed items.

The terminology used herein is for the purpose of describing particular embodiments only and is not intended to limit the full scope of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element such as an object, layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, components, regions, layers and/or sections, these elements, components, regions, layers and/or sections should not be limited by these terms. For example, when referring first and second elements, sections, regions, or layers, these terms are only used to distinguish one element, section, region or layer from another element, section, region or layer. Thus, a first element, section, region, or layer discussed below could be termed a second element, section, region, or layer without departing from the teachings of the present invention.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in the Figures is turned over, elements described as being on the “lower” side or “bottom” of other elements would then be oriented on “upper” sides or “top” of the other elements. The exemplary term “lower” or “bottom,” can therefore, encompass both an orientation of “lower” (bottom) and “upper” (top), depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes. Thus, the shapes or regions illustrated in the figures are schematic in nature and their shapes are not intended to illustrate the precise shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will also be appreciated by those of skill in the art that references to a structure or feature that is disposed “adjacent” another feature may have portions that overlap or underlie the adjacent feature.

When a reflective structure, such as an electronic band gap structure, is used in conjunction with an antenna, the phase of the reflected wave is important because of destructive interference of the wave reflected from the ground plane with the wave directly radiated from the antenna. Instead, using a magnetic ground plane having electronic band gap structures formed thereon (with high impedance) allows for the construction of low-profile antennas. One characteristic of the electronic band gap structures (when used in an antenna embodiment) is the constructive addition of the incident and reflected waves, thereby reducing backward radiation and enhancing forward radiation. Although electronic band gap structures have been known in microwave design for more than two decades and are known to provide advantages due to their compact size and low loss when integrated into an antenna design, electronic bandgap or high impedance antenna wave reflection structures typically work over a narrow frequency band, which makes them not practical for use with broadband antennas. A preferred embodiment of the present invention is directed to overcoming this deficiency.

A preferred embodiment of the present invention comprises a reflective structure wherein the bandwidth of the electronic band gap structure may be improved by stacking EBG structures that resonate close to each other as summarized herein. The approach of the preferred embodiment improves bandwidth using multiple resonances.

In accordance with the principles of the present invention, Equations 1 through 5 give the surface impedance, resonance frequency, inductance, capacitance and the bandwidth, respectively, of an electronic structure. Around the resonance frequency the surface impedance of the electronic structure is very high, and thus does not support a surface wave, so the incident wave is reflected in-phase, which helps enhance the forward radiation of the antenna placed on the surface. A wave incident on a perfect electric conductor (PEC) is reflected 180 degrees out of phase. Since the total tangential component has to go to zero, this results in the reflected wave cancelling with the incident wave and resulting in a null in the radiation pattern at boresight. The band gap of an EBG structure is defined as the frequency band where the reflection phase is in the +90 to −90 degree range. Reflection phase of the electronic structure is calculated by using a plane wave incidence, determining the phase of the received signal at boresight in the far field, and then comparing it with a known reflection phase (e.g. PEC plate). Uniform EBG structures usually have narrow bandwidth, which is the primary reason why they are not widely used with broadband antennas.

$$\begin{matrix}{Z}_{s} = \frac{j ω L}{1 - {( \frac{ω}{{ω}_{0}} )}^{2}} & ( 1 ) \\ {ω}_{0} = \frac{1}{\sqrt{LC}} & ( 2 ) \\ L = {μ}_{0} t & ( 3 ) \\ C = \frac{W {ɛ}_{0} ( 1 + {ɛ}_{r} )}{π} {cosh}^{- 1} ( \frac{2 W + g}{g} ) & ( 4 ) \\ BW = \frac{1}{120 π} \sqrt{\frac{L}{C}} & ( 5 )\end{matrix}$$

To increase the bandwidth of a uniform EBG, a progressive EBG structure, formed by cascading uniform EBG structures that resonate at different bands, is proposed in A. I. Zaghloul, S. Palreddy, S. J. Weiss, “A Concept for a Broadband Electromagnetic Band Gap (EBG Structure,” Proceedings of the 5th European Conference on Antennas and Propagation (EuCAP), pp 383-387, April 2011, hereby incorporated by reference. Progressive EBG structures can be used with antennas where different parts of the antenna radiate at different frequencies. This design is not a good candidate to use with broadband antennas when the whole structure contributes to the radiation across the band.

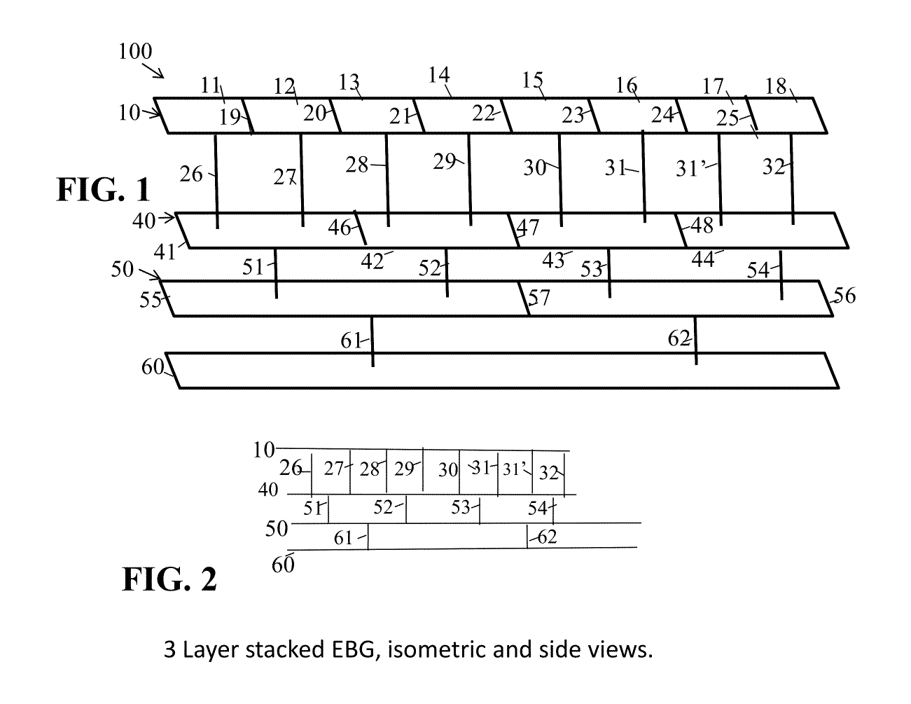

A preferred embodiment is directed to a broadband antennas comprising a stacked EBG structure formed by stacking layers that resonate at different frequencies within the operating band. The outer most layer (closest to the antenna (not shown)) comprises patches 11- 18, which are separated by gaps 19-25 as shown in FIG. 2. The patches 11-18 may be made from a metallic material such as copper, gold or silver and may be placed on a nonconductor substrate such as silicon , in that case the silicon would extended in the gaps 19-25. The silicon substrate would extend across the area shown and patches 11-18 may be formed by etching a copper sheet formed on the substrate layer. Patches 11-18 are supported by supports 26 through 32, as shown in FIG. 1, but optionally may be supported by a singular piece of dielectric such as ceramic or foam material to thereby eliminate the need for supports 26-32. The second layer comprises patches 41 through 44, which may be made from a metallic material such as copper, gold or silver and may be placed on a nonconductor substrate such as silicon. Patches 41 through 44 are separate by gaps 45-48 which produce a different resonance effect than that of patches 11-18 and gaps 19-25. Patches 41 through 44 may be formed by eching a metallic sheet formed on the substrate layer; in that case the substrate layer, such as for example, silicon, would extend in the gaps 46, 47 and 48. The second layer of patches 41 through 44 may be supported by the supports 51 through 54, but optionally may be supported by a singular piece of dielectric such as ceramic or foam material to thereby eliminate the need for supports 51 through 54. The third layer of patches 55 and 56 are separated by a gap 57, which may be produced by etching a metallic sheet. The patches 56 and 57 may be made from a metallic material such as copper, gold or silver and may be placed on a nonconductor substrate such as silicon , in that case the silicon would extended in the gap 57. The third layer of patches 55 through 56 may be supported by the supports 61 and 62, but optionally may be supported by a singular piece of dielectric such as ceramic or foam material to thereby eliminate the need for supports 61 and 62. The fourth layer comprises patch 60, which may be made from a metallic material such as copper, gold or silver and may be placed on a nonconductor substrate such as silicon. It can be appreciated by those of ordinary skill in the art that each of the four layers provide a reflective structure wherein the bandwidth of the structure is improved by stacking layers that resonate at frequency bands that extend over different frequency band ranges yet the resonate frequency ranges of the layers 10, 40, 50 and 60 are substantially close to one other so as to provide a wide band-gap area of operation for the entire assembly. Shown in FIG. 2 is side view of the assembly 100 shown in FIG. 1.

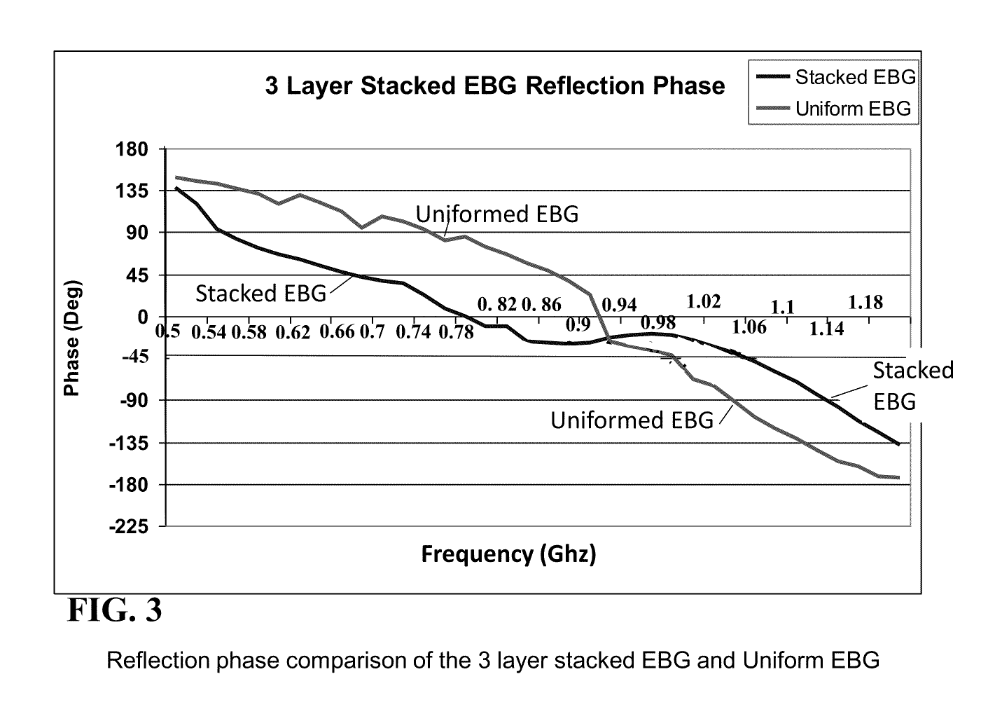

The dimensions of the stacked layers 10, 40, 50 and 60 are functions of the desired resonance frequencies. Using FEKO (see FEKO: Computational Electromagnetics EM Software and Systems Pty Ltd. http:/www.feko.info), the reflection phase of the stacked EBG is computed and, compared with the reflection phase of a uniform EBG, as shown in FIG. 3. The dimensions of the uniform EBG are selected such that it resonates at 0.9 GHz. The dimensions of the 3-layer stacked EBG are selected such that the bottom layer resonates at 0.6 GHz, the middle layer resonates at 0.9 GHz, and the top layer resonates at 1.1 GHz.

The reflection phase change of the stacked EBG shows a +90 to −90 degree variation over a broader frequency band compared with the uniform EBG layer. The stacked EBG example shows an octave bandwidth (see FIG. 3).

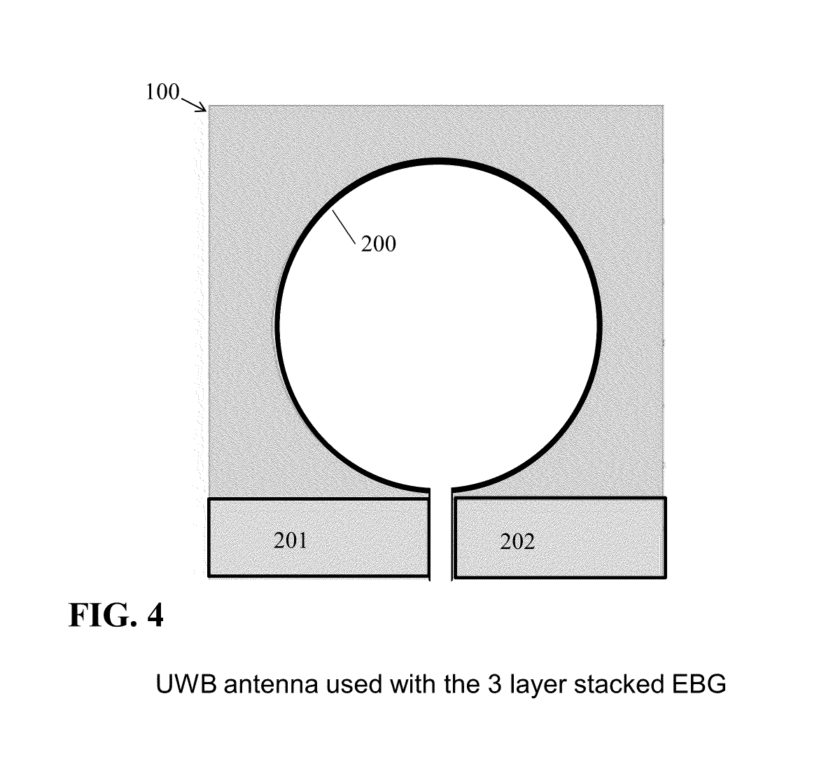

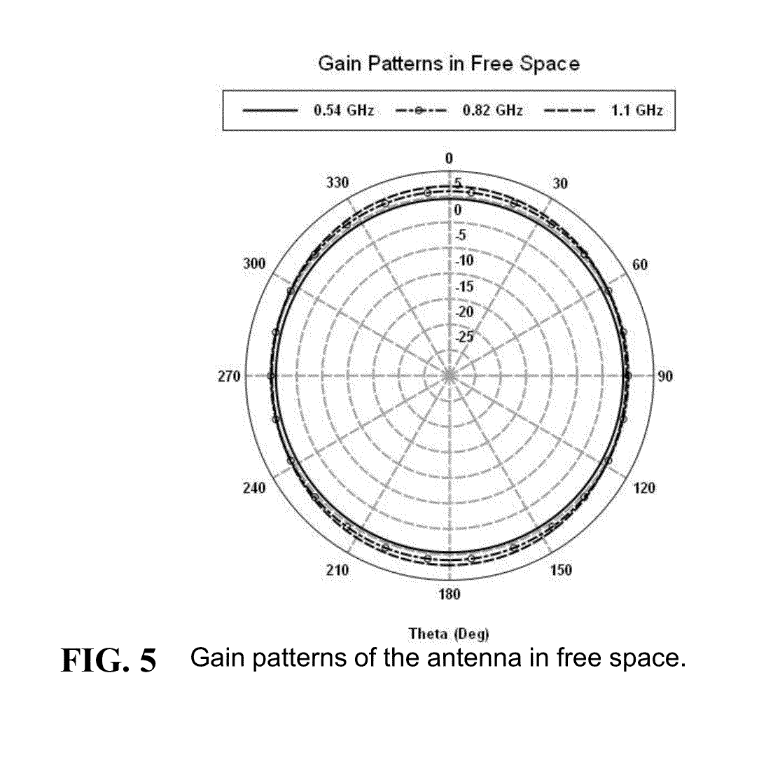

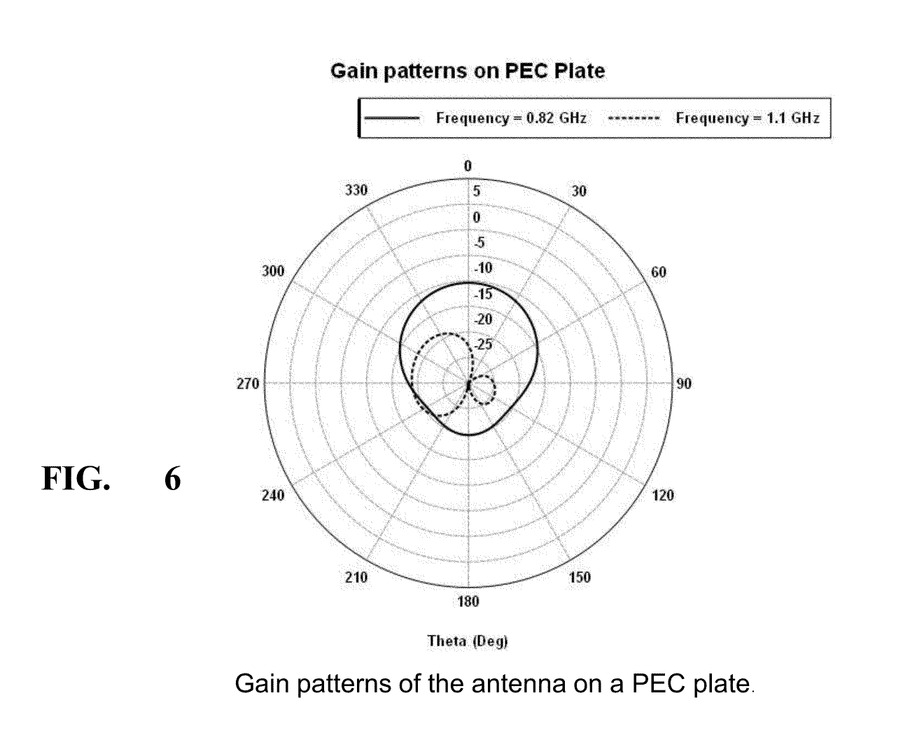

FIG. 4 is a diagrammatic illustration of a preferred embodiment stacked EBG structure 100 with an UWB monopole antenna. The performance of the monopole antenna in free space is taken as a benchmark and is compared with the performance of the antenna near a uniform EBG and the three-layer stacked EBG. To better understand the effects of the antenna near a ground plane, the performance of the antenna on a ground plane is also used for the comparison purposes. FIG. 5 shows the gain patterns of the monopole antenna in free space, while FIG. 6 shows the gain patterns of the antenna on a perfect electric conductor (PEC) plate.

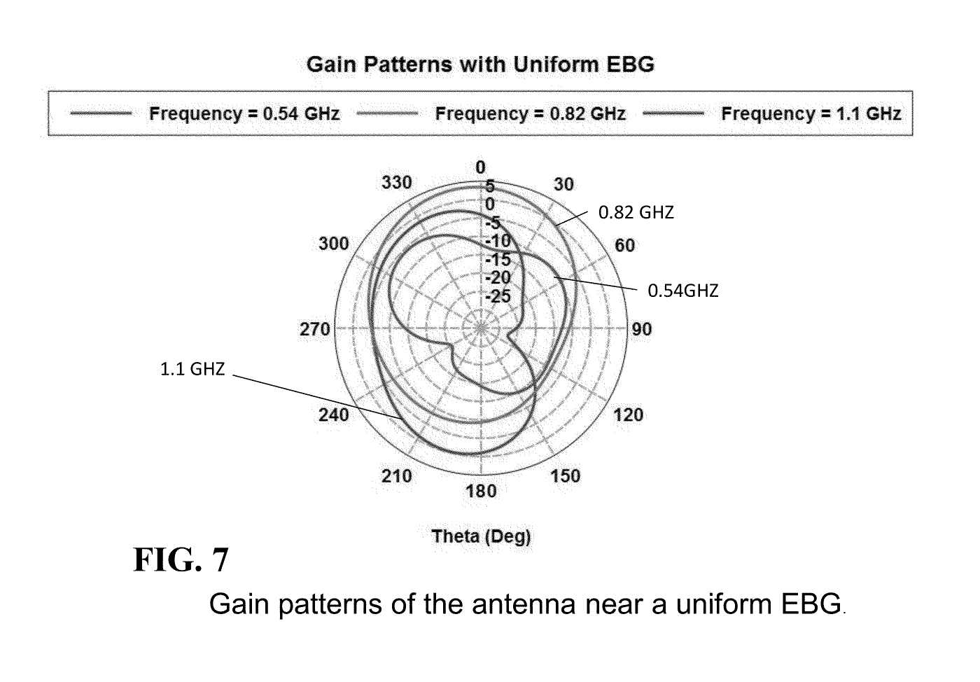

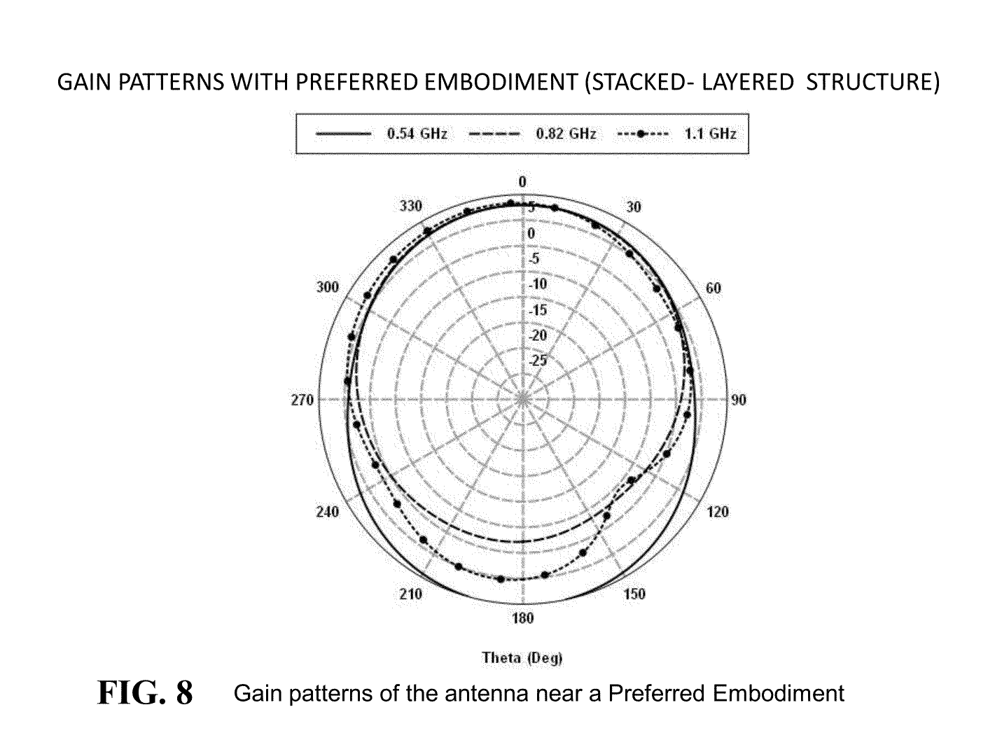

Comparing FIGS. 5 and 6 it can be easily seen that the presence of a conducting plate has degraded the performance of the antenna, because the reflected wave from the PEC plate cancels the forward radiating wave and yields very low gain at boresight. FIG. 7 shows gain patterns of the antenna near a uniform EBG structure, while FIG. 8 shows gain patterns of the antenna near a preferred embodiment 3-layer stacked EBG structure.

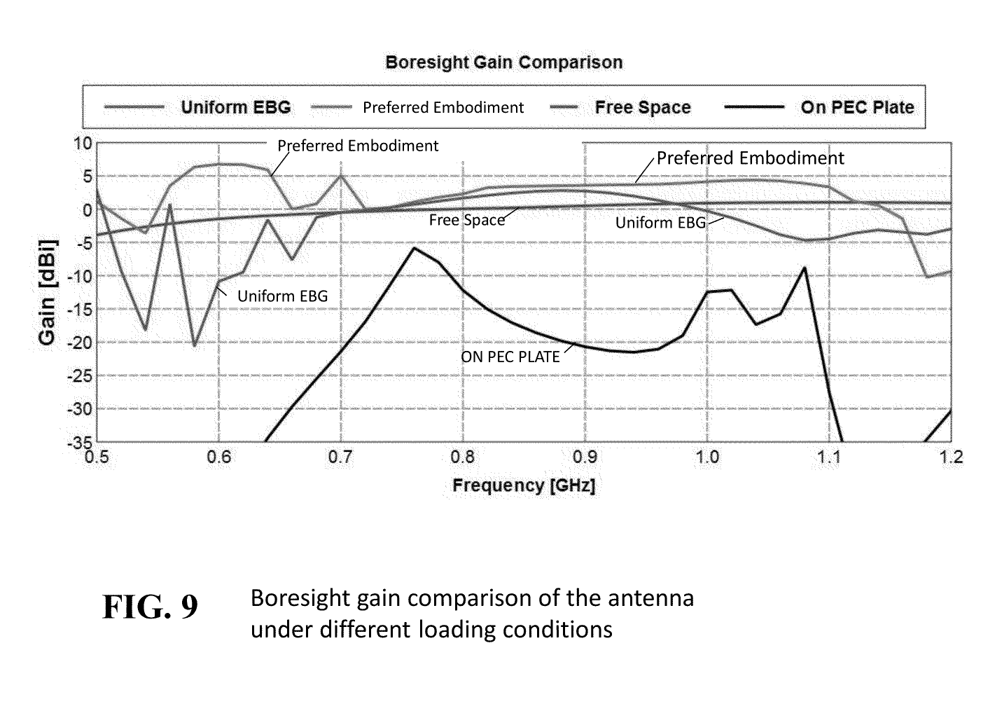

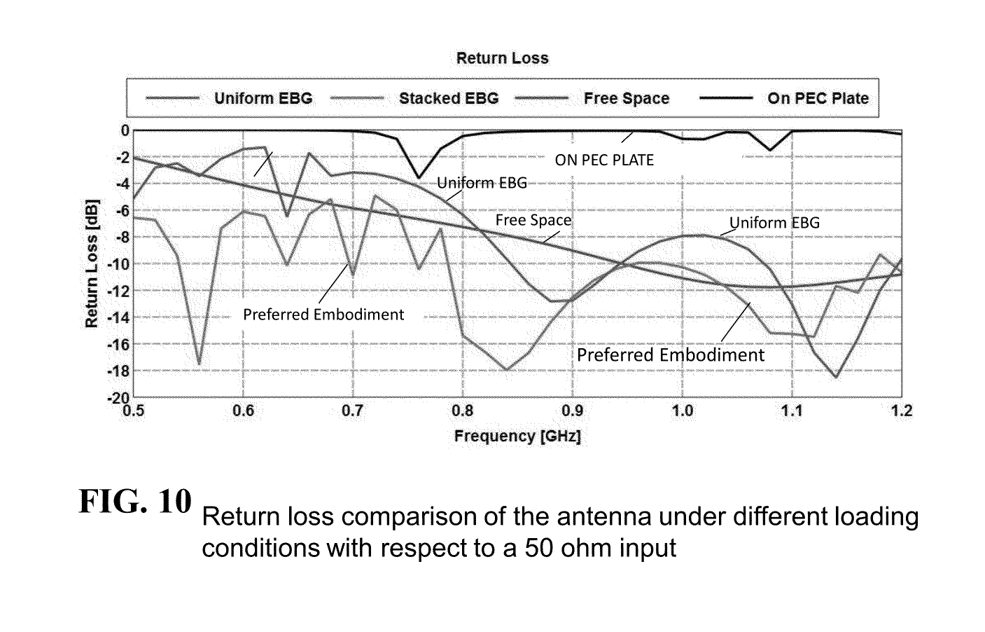

Comparing FIGS. 7 and 8 it can be seen that the uniform electronic band gap structure (EBG) does not have the required bandwidth to cover the octave band of interest (550 MHz to 1100 MHz), a fact that is proved in FIG. 3. It can also be seen that the stacked EBG has the required bandwidth to cover the octave bandwidth as shown in FIGS. 3 and 8. FIG. 9 compares the boresight gain of the antenna under different loading conditions, while FIG. 10 shows the return loss performance of the antenna under different loading conditions. It can be seen from FIGS. 9 and 10 that the stacked EBG has the required bandwidth, as its gain and return loss are better than free space case from 550 MHz to 1100 MHz, while the uniform EBG does not have the required bandwidth to cover the entire bandwidth.

The stacked EBG concept described here can serve as a broadband reflector in many antenna applications without the restriction of being a quarter-wavelength from the source. Its main use is to reduce the depth of cavity backed antennas which require broader bandwidth than conventional EBG designs can provide. This allows the integration of conformal antennas with reduced depth onto military platforms. Lower profile antennas have many advantages on the modern battlefield. The stacked EBG concept is an enabling technology for advanced antenna designs and vehicle integrated antennas compared to bolt-on antenna installations.

The concept and/or scope of the present invention is not limited to three layers and additional layers can further extend the bandwidth at the expense of increased fabrication complexity. For some antenna types non-uniform or progressive EBG layers can be incorporated to improve performance. Additional layers can be used to extend bandwidth and/or increase gain where the design of the EBG structure is specific to the antenna and can be readily optimized for a given application. The fabrication cost and complexity are current issues being addressed. In particular an approach that does not use vertical vias is being pursued to reduce cost, weight and fabrication complexity. Such variations are also covered by this concept disclosure and are important for the further development of EBG structures in practical antenna installations.

The present invention affords a way to increase the bandwidth of a single uniform EBG structure by stacking uniform EBG layers that resonate at different frequencies within the desired frequency band. The performance of the stacked EBG is validated by using it with a monopole UWB antenna. Its performance is compared with different loading structures to demonstrate its superiority for many antenna applications. Boresight gain, gain patterns and return loss of the antenna are compared under the loading conditions of free space, metal plate, uniform single-resonance EBG, and stacked triple-resonance EBG.

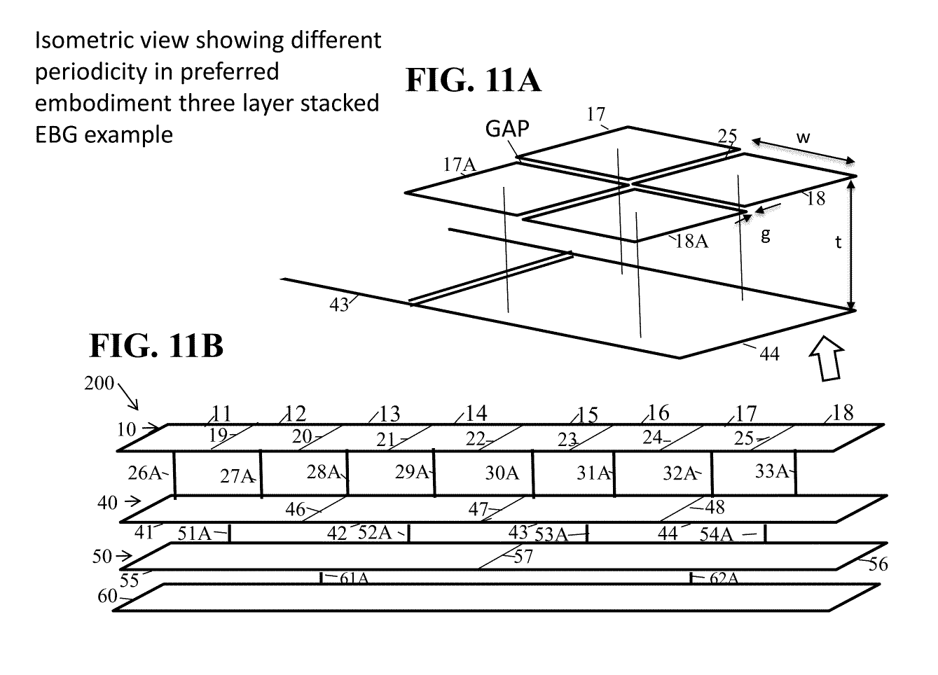

FIG. 11A is an isometric view showing the different periodicity in a three layer stacked preferred embodiment example, showing patches 17A and 18A extending in the manner shown.

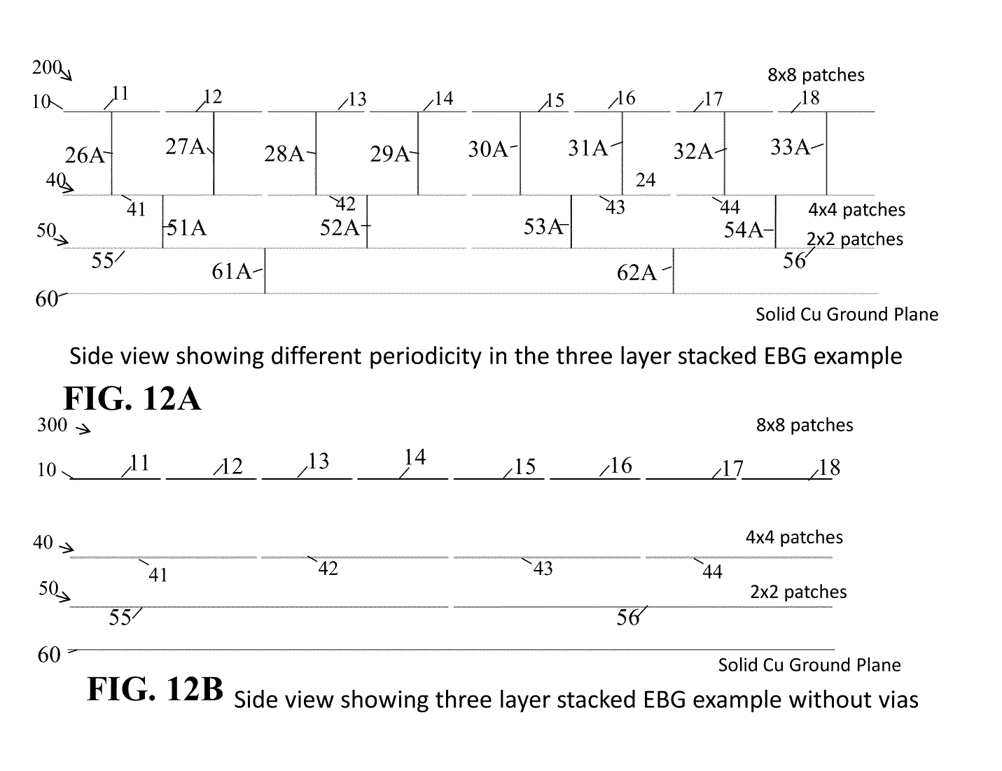

FIG. 11B is an alternative preferred embodiment 200 comprising a stacked EBG structure formed by stacking layers that resonate at different frequencies within the operating band. The outer most layer (closest to the antenna (not shown)) comprises patches 11-18, which are separated by gaps 19-25 as shown in FIG. 2. The patches 11-18 may be made from a metallic material such as copper, gold or silver and may be placed on a nonconductor substrate such as silicon , in that case the silicon would extended in the gaps 19-25. The silicon substrate would extend across the area shown and patches 11-18 may be formed by etching a copper sheet formed on the substrate layer. Patches 11-18 are supported by supports 26A through 32A, as shown in FIG. 1, but optionally may be supported by a singular piece of dielectric such as ceramic or foam material to thereby eliminate the need for supports 26A-32A. The second layer comprises patches 41 through 44, which may be made from a metallic material such as copper, gold or silver and may be placed on a nonconductor substrate such as silicon. Patches 41 through 44 are separate by gaps 45-48 which produce a different resonance effect than that of patches 11-18 and gaps 19-25. Patches 41 through 44 may be formed by eching a metallic sheet formed on the substrate layer; in that case the substrate layer, such as for example, silicon, would extend in the gaps 46, 47 and 48. The second layer of patches 41 through 44 may be supported by the supports 51A through 54A, but optionally may be supported by a singular piece of dielectric such as ceramic or foam material to thereby eliminate the need for supports 51 through 54. The third layer of patches 55 and 56 are separated by a gap 57, which may be produced by etching a metallic sheet. The patches 56 and 57 may be made from a metallic material such as copper, gold or silver and may be placed on a nonconductor substrate such as silicon, in that case the silicon would extended in the gap 57. The third layer of patches 55 through 56 may be supported by the supports 61A and 62A, but optionally may be supported by a singular piece of dielectric such as ceramic or foam material to thereby eliminate the need for supports 61A and 62A. The fourth layer comprises patch 60, which may be made from a metallic material such as copper, gold or silver and may be placed on a nonconductor substrate such as silicon. It can be appreciated by those of ordinary skill in the art that each of the four layers provide a reflective structure wherein the bandwidth of the structure is improved by stacking layers that resonate at frequency bands that extend over different frequency band ranges yet the resonate frequency ranges of the layers 10, 40, 50 and 60 are substantially close to one other so as to provide a wide band-gap area of operation for the entire assembly. Shown in FIG. 12A is side view of the assembly 100 shown in FIG. 11B.

FIG. 12A is a side view schematic illustration of the preferred embodiment assembly 200 (shown also in FIG. 11B).

FIG. 12B is side view of an alternative preferred embodiment 300 comprising a stacked EBG structure formed by stacking layers that resonate at different frequencies within the operating band. The outer most layer (closest to the antenna (not shown)) comprises patches 11-18, which are separated by gaps 19-25 as shown in FIG. 2. The patches 11-18 may be made from a metallic material such as copper, gold or silver and may be placed on a nonconductor substrate such as silicon , in that case the silicon would extended in the gaps 19-25. The silicon substrate would extend across the area shown and patches 11-18 may be formed by etching a copper sheet formed on the substrate layer. Patches 11-18 may be supported by a singular piece of dielectric such as ceramic or foam material to thereby eliminate the need for supports. The second layer comprises patches 41 through 44, which may be made from a metallic material such as copper, gold or silver and may be placed on a nonconductor substrate such as silicon. Patches 41 through 44 are separate by gaps 45-48 which produce a different resonance effect than that of patches 11-18 and gaps 19-25. Patches 41 through 44 may be formed by etching a metallic sheet formed on the substrate layer; in that case the substrate layer, such as for example, silicon, would extend in the gaps 46, 47 and 48. The second layer of patches 41 through 44 may be supported by a singular piece of dielectric such as ceramic or foam material to thereby eliminate the need for vertical supports or vias. The third layer of patches 55 and 56 are separated by a gap 57, which may be produced by etching a metallic sheet. The patches 56 and 57 may be made from a metallic material such as copper, gold or silver and may be placed on a nonconductor substrate such as silicon , in that case the silicon would extended in the gap 57. The third layer of patches 55 through 56 may be supported by a singular piece of dielectric such as ceramic or foam material to thereby eliminate the need for vertical supports. The fourth layer comprises patch 60, which may be made from a metallic material such as copper, gold or silver and may be placed on a nonconductor substrate such as silicon. It can be appreciated by those of ordinary skill in the art that each of the four layers provide a reflective structure wherein the bandwidth of the structure is improved by stacking layers that resonate at frequency bands that extend over different frequency band ranges yet the resonate frequency ranges of the layers 10, 40, 50 and 60 are substantially close to one other so as to provide a wide band-gap area of operation for the entire assembly.

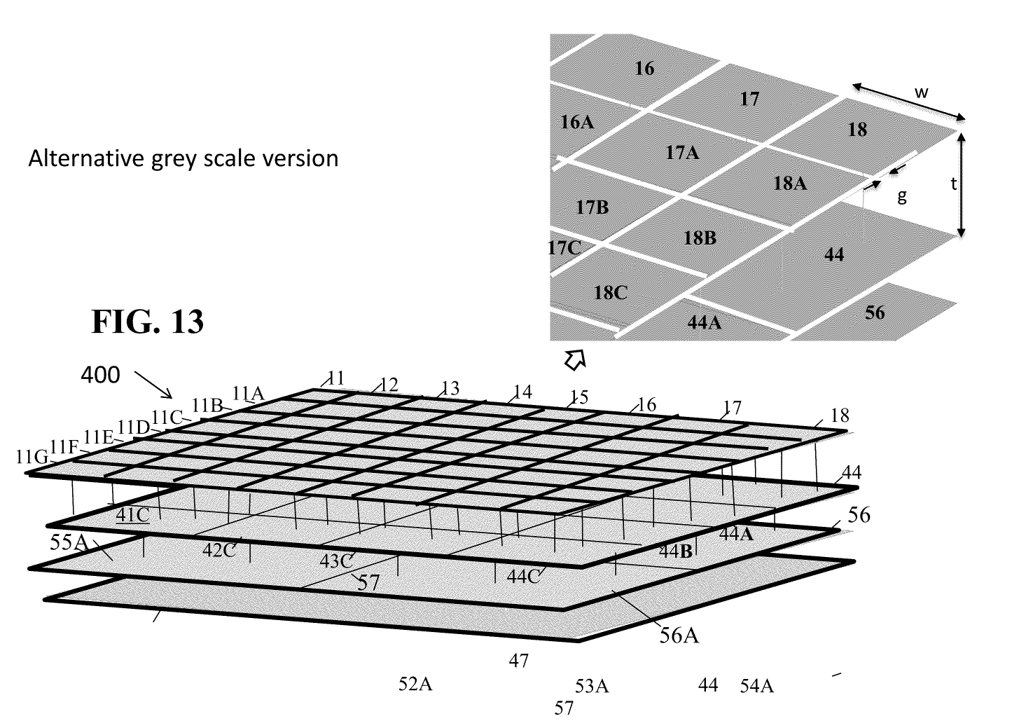

FIG. 13 is a schematic illustration of an alternate embodiment with first layer patches 11 through 14 extending in multiple directions. In this alternative preferred embodiment the layers resonate at different frequencies within the operating band. The outer most layer (closest to the antenna (not shown)) comprises patches 11(A-G)-18(A-G), which are separated by gaps as shown in FIG. 2. The patches 11(A-G)-18(A-G), may be made from a metallic material such as copper, gold or silver and may be placed on a nonconductor substrate such as silicon , in that case the silicon would extended in the gaps. The silicon substrate would extend across the area shown and patches 11(A-G)-18(A-G), may be formed by etching a copper sheet formed on the substrate layer. Patches 11(A-G)-18(A-G), are supported by supports, as shown in FIG. 13, but optionally may be supported by a singular piece of dielectric such as ceramic or foam material to thereby eliminate the need for supports. The second layer comprises patches 41(A-C) through 44 (A-C), which may be made from a metallic material such as copper, gold or silver and may be placed on a nonconductor substrate such as silicon. Patches 41(A-C) through 44 (A-C)are separate by gaps which produce a different resonance effect than that of patches 11(A-G)-18(A-G) and gaps 19-25. Patches 41(A-C) through 44 (A-C) may be formed by etching a metallic sheet formed on the substrate layer; in that case the substrate layer, such as for example, silicon, would extend in the gaps. The second layer of patches 41(A-C) through 44 (A-C) may be supported by the supports, but optionally may be supported by a singular piece of dielectric such as ceramic or foam material to thereby eliminate the need for supports. The third layer of patches 55, 55A, 56, and 56A are separated by a gap 57, which may be produced by etching a metallic sheet. The patches 55, 55A, 56, and 56A may be made from a metallic material such as copper, gold or silver and may be placed on a nonconductor substrate such as silicon , in that case the silicon would extended in the gap 57. The third layer of patches 55, 55A, 56, and 56A may be supported by the supports, but optionally may be supported by a singular piece of dielectric such as ceramic or foam material to thereby eliminate the need for supports. The fourth layer comprises patch 60, which may be made from a metallic material such as copper, gold or silver and may be placed on a nonconductor substrate such as silicon. It can be appreciated by those of ordinary skill in the art that each of the four layers provide a reflective structure wherein the bandwidth of the structure is improved by stacking layers that resonate at frequency bands that extend over different frequency band ranges yet the resonate frequency ranges of the layers 10, 40, 50 and 60 are substantially close to one other so as to provide a wide band-gap area of operation for the entire assembly.

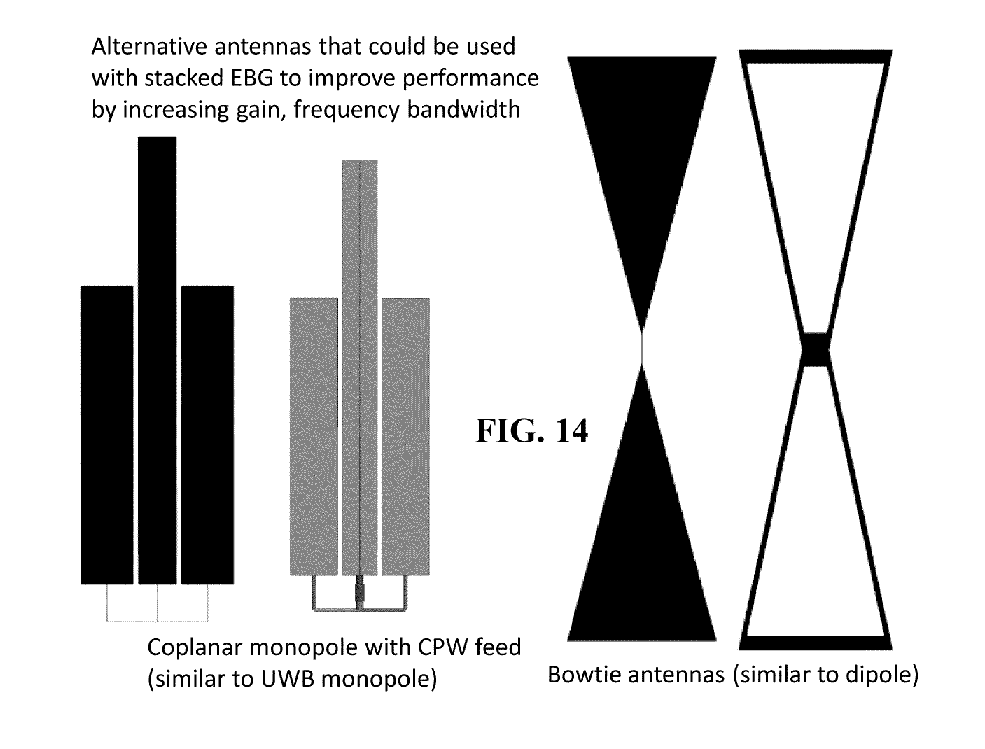

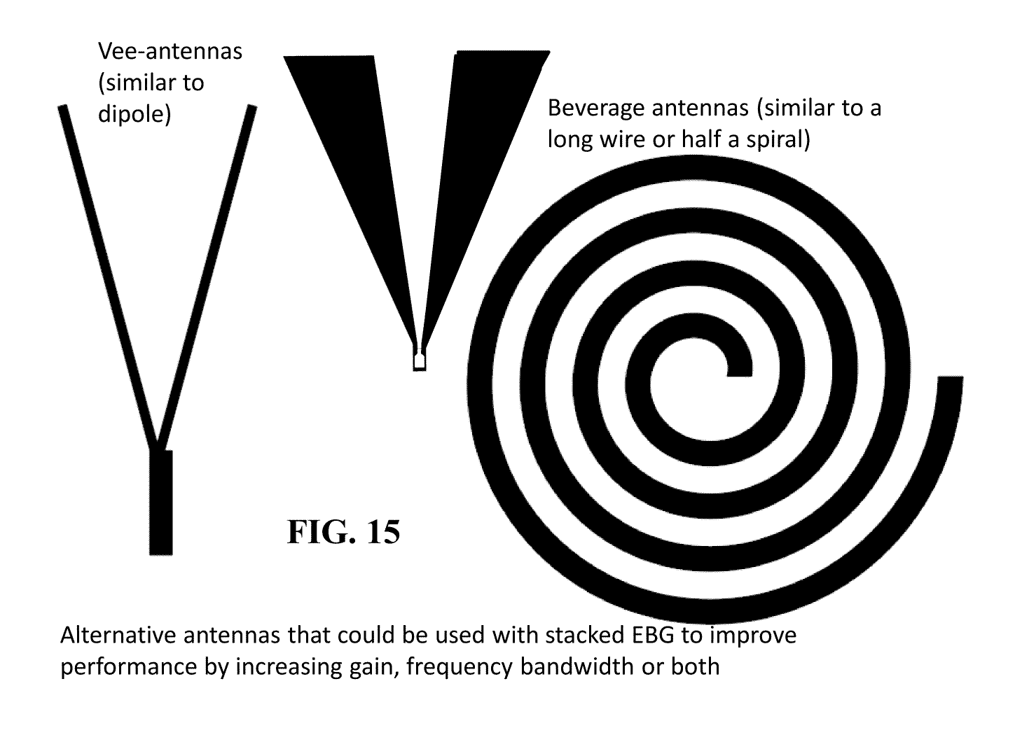

FIG. 14 schematically illustrates antennas that may be used in connection with the preferred embodiments described above. For example, the coplanar monopole and bow tie antennas. FIG. 15 schematically illustrates antennas that may be used in connection with the preferred embodiments described above. For example, the beverage antennas and Vee antennas.

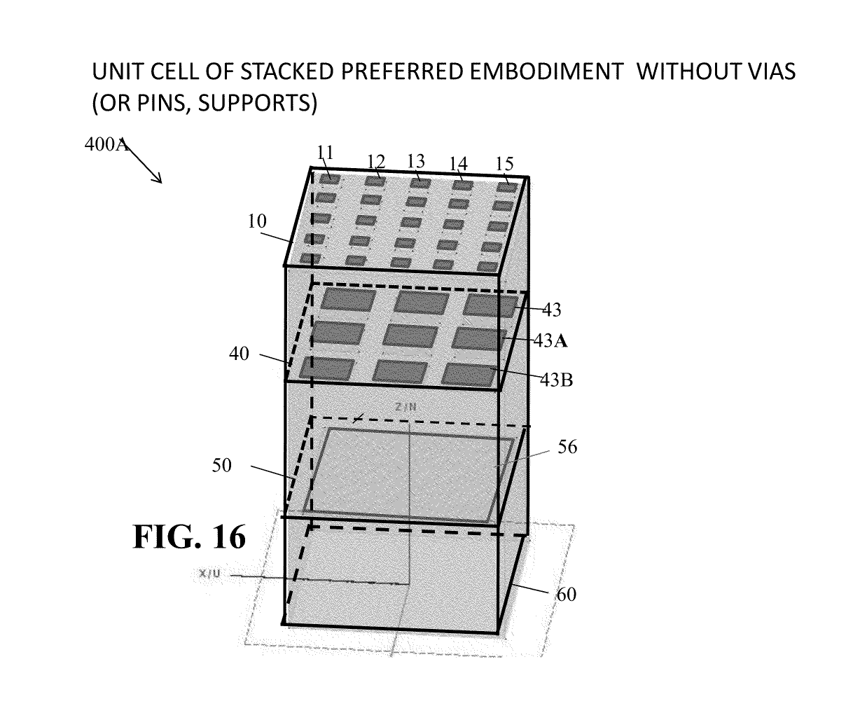

FIG. 16 is a schematic three dimensional configuration of an alternate preferred embodiment wherein the patches 11-15, 41-43, and 56 are support by a dielectric. In this alternative preferred embodiment the layers resonate at different frequencies within the operating band. The outer most layer (closest to the antenna (not shown)) comprises patches 11(A-D)-15(A-D), which are separated by gaps as shown in FIG. 16. The patches 11(A-D)-15(A-D), may be made from a metallic material such as copper, gold or silver and may be placed on a nonconductor substrate such as a dielectric, (such as silicon), in that case the dielectric would extended in the gaps. The silicon substrate would extend across the area shown and patches 11(A-D)-15(A-D), may be formed by etching a copper sheet formed on the substrate layer. Patches 11(A-D)-15(A-D), are supported a singular piece of dielectric such as ceramic or foam material to thereby eliminate the need for supports. The second layer comprises patches 41, 41A, 41B through 43, 43A, 43B, which may be made from a metallic material such as copper, gold or silver and may be placed on a nonconductor substrate such as silicon. Patches 41, 41A, 41B through 43, 43A, 43B are separate by gaps which produce a different resonance effect than that of patches 11(A-D)-15(A-D). Patches 41, 41A, 41B through 43, 43A, 43B may be formed by etching a metallic sheet formed on the substrate layer; in that case the substrate layer, such as for example, silicon, would extend in the gaps. The second layer of patches 41, 41A, 41B through 43, 43A, 43B may be supported by a singular piece of dielectric such as ceramic or foam material to thereby eliminate the need for supports. The third layer comprising patch 56, may be made from a metallic material such as copper, gold or silver and may be placed on a nonconductor substrate such as silicon. The third layer may be supported by the supports, but optionally may be supported by a singular piece of dielectric such as ceramic or foam material to thereby eliminate the need for supports. The fourth or base layer 60, which may be made from a metallic material such as copper, gold or silver and may be placed on a nonconductor substrate such as silicon. It can be appreciated by those of ordinary skill in the art that each of the four layers provide a reflective structure wherein the bandwidth of the structure is improved by stacking layers that resonate at frequency bands that extend over different frequency band ranges yet the resonate frequency ranges of the layers 10, 40, and 50 are substantially close to one other so as to provide a wide band-gap area of operation for the entire assembly.

As used herein the terminology “substantially optimal magnetic conductor” means a conductor having nearly perfect magnetic conductance.

As used herein, the terminology “resonance” relates to electromagnetic resonance and relates to the tendency of a system or structure to oscillate with greater amplitude at some frequencies than at others. Resonant or resonance frequencies occur when the response amplitude is a relative maximum.

As used here in a cavity resonator is a hollow conductor blocked at both ends and along which an electromagnetic wave can be supported, similar in nature to a waveguide short-circuited at both ends. The cavity's interior surfaces reflect a wave of a specific frequency. When a wave that is resonant with the cavity enters, it bounces back and forth within the cavity, with low loss (forming a standing wave). As more wave energy enters the cavity, it combines with and reinforces the standing wave, increasing its intensity.

As used herein the word “size” is not limited to a measure of physical characteristics, but also includes a measure of electrical characteristics.

As used herein the terminology “incident” radiation refers to the radiation hitting a specific surface.

As used herein the terminology “stacked” means an orderly pile, such as, for example, one arranged in layers.

As used herein the terminology “UWB” or ultra wide frequency band” means a transmission from an antenna for which the emitted signal bandwidth exceeds the lesser of 500 MHz or 20% of the center frequency.

The foregoing description of the specific embodiments are intended to reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. An electromagnetic structure for reflecting electromagnetic waves comprising:
a first surface having spaced patches of conductive material thereon;
a second surface separated from the first surface, having spaced patches of conductive material, the first and second surfaces having high impedance and forming substantially optimal magnetic conductors;
the electromagnetic structure adapted to be used in conjunction with an associated antenna that radiates electromagnetic radiation originating therefrom, the radiation is reflected by the electromagnetic structure such that the phase of the electromagnetic waves reflected from first and second surfaces results in the constructive addition of the originating and reflected waves, thus enhancing the radiation of electromagnetic waves by the associated antenna.

2. The structure of claim 1 wherein the first and second surfaces are stacked layers, each layer resonating at a different frequency leading to a plurality of resonances at different frequencies resulting in operation of the associated antenna at a broadband of frequencies.

3. The structure of claim 2 wherein each of the multiple resonances is a function of the spacing between patches of conductive material and the size of the patches.

4. The structure of claim 3 wherein the resonance is created within the cavity defined between the first and second surfaces.

5. The structure of claim 1 wherein the first and second layers are substantially planar and are substantially parallel to one another and wherein the electromagnetic waves are reflected in the forward direction, away from the first surface

6. The structure of claim 3 wherein the first and second layers are separated by at least one dielectric material, and wherein the spacing between the first and second layers forms a resonant cavity.

7. The structure of claim 6 wherein the dielectric is one of ceramic, foam and plastic.

8. The structure of claim 1 wherein the structure is flexible and conforms to an object upon which it is mounted.

9. The structure of claim 8 wherein the structure conforms to one of a human body, an airplane and a vehicle.

10. The structure of claim 4 wherein first and second layers are uniform electromagnetic band-gap layers that resonate at different frequencies within a predetermined operating band.

11. A multiple-layer stacked electronic structure comprising:
at least two layers comprising electronic band gap surfaces; each layer being in the stacked arrangement.

12. The structure of claim 7 wherein the at least two layers comprise at least three layers arranged as top, middle and bottom layers, and wherein the dimensions of the 3-layer stacked EBG are selected such that the bottom layer resonates at 0.6 GHz, the middle layer resonates at 0.9 GHz. and the top layer resonates at 1.1 GHz.

13. An electromagnetic structure for reflecting electromagnetic waves comprising:
a first planar area comprising a first plurality of spaced apart patches of conductive material; the first plurality of spaced apart patches operating to reflect electromagnetic waves in a first frequency range;
a second planar area substantially parallel to and separated from the first planar area, the second planar area comprising a second plurality of spaced apart patches of conductive material operating to reflect electromagnetic waves in a second frequency range;
a third planar area substantially parallel to and separated from the first and second planar areas, the third planar area comprising a third plurality of spaced apart patches of conductive material operating to reflect electromagnetic waves in a third frequency range; the first, and third frequency ranges being additive such that the electromagnetic structure reflects electromagnetic waves in a ultra wide frequency band;
whereby the electromagnetic structure is adapted to be used in conjunction with an associated antenna that radiates electromagnetic radiation originating therefrom, the radiation being reflected by the electromagnetic structure being such that the phase of the electromagnetic waves reflected from first and second layers results in the constructive addition of the originating and reflected waves, thus enhancing the radiation of electromagnetic waves by the associated antenna.

14. The electromagnetic structure further comprising a base layer which conforms in shape to the object upon which the electromagnetic structure is secured, the object being one of a human body, aircraft and motor vehicle and wherein the range of the ultra wide frequency band exceeds 500 MHZ.

15. The electromagnetic structure of claim 13 wherein the first, second and third plurality of patches have different sizes so as to produce a resonate effect at different ranges of frequency.

16. The electromagnetic structure of claim 13 further comprising to base and wherein the first, second and third plurality of patches extend in two dimensions, and wherein the first, second and third plurality of patches are supported by a first, second and third plurality of supports, the first supports extending between the first plurality of patches and second plurality of patches, the second supports extending between the second. plurality of patches and third plurality of patches, the third supports extending between the third plurality of patches and the base.

17. The electromagnetic structure of claim 16 wherein the region between the first planar area and second planar area comprises a first resonant cavity and the region between the second planar area and third planar area comprises a second resonant cavity, the first and second resonant cavities each operating to form first and second resonant tank circuits; the capacitance of the first resonant tank circuit being dependent upon the distance between the first and second plurality of patches, and the capacitance of the second resonant tank circuit being dependent upon the distance between the second and third patches, and wherein the inductance of the first and second resonant tank circuits comprises the electrical characteristics of the first and second supports, respectfully.

18. The electromagnetic structure of claim 13 wherein the radiation reflected by the electromagnetic structure from the antenna is such that the phase of the electromagnetic waves reflected from first, second and third planar areas results in the constructive addition of the originating and reflected waves, thus enhancing the radiation of electromagnetic waves by the associated antenna.

19. The electromagnetic structure of claim 13 further comprising a base and wherein the first, second and third plurality of patches extend in two dimensions, and wherein the first, second and third plurality of patches are supported by a first, second and third dielectric layers.

20. The electromagnetic structure of claim 16 wherein the region between the first planar area and second planar area comprises a first resonant cavity and the region between the second planar area and third planar area comprises a second resonant cavity, the first and second resonant cavities each operating to form first and second resonant tank circuits the capacitance of the first resonant tank circuit being dependent upon the distance between the first and second plurality of patches, and the capacitance of the second resonant tank circuit being dependent upon the distance between the second and third patches, and wherein the inductance of the first and second resonant tank circuits comprises the electrical characteristics of the first, second and third dielectrics, respectively.
